(19) United States
(12) Patent Application Publication
(10) Pub. No.: US 2010/0183365 A1
(43) Pub. Date: Jul. 22, 2010

(54) Assembly and Mounting Rack

(75) Inventor: Günther DEINHARDT, Amberg (DE)

Correspondence Address: COHEN, PONTANI, LIEBERMAN & PAVANE LLP, 551 FIFTH AVENUE, SUITE 1210, NEW YORK, NY, 10176, US

(73) Assignee: Siemens AG, Munchen (DE)

(21) Appl. No.: 12/690,701

(22) Filed: Jan. 20, 2010

(30) Foreign Application Priority Data
Jan. 22, 2009 (EP) 09 151 112

(51) Int. Cl. F16B 5/07

(52) U.S. Cl. 403/322.4

(57) ABSTRACT

An assembly for pivoting into a mounting rack includes a housing upon which a first holding device is arranged for connection to a first attachment device of the mounting rack. The connection permits the housing to pivot. A locking lever is rotatably mounted on the housing. A second holding device arranged at a first end of the locking lever and a second end of the locking lever is moveable in the direction of the housing for the second holding device to engage in a second attachment device of the mounting rack.

### BACKGROUND OF THE INVENTION

1. Field of the Invention

The invention relates to an assembly configured to pivot into a mounting rack, wherein the assembly comprises a housing in the form of a box on which a first holding means is arranged for connection to a first attachment means of the mounting rack, and wherein the housing can be pivoted by means of this connection. The invention also relates to a mounting rack for holding the assembly.

2. Description of the Related Art

In the field of automation, it is known for assemblies to be inserted into mounting racks, and for a modular system thus to be constructed. In this case, the assemblies must be securely anchored in the mounting rack, and must be secured against falling out. Furthermore, it may be important, particularly in the case of safety production or manufacturing installations, to configure an installation to allow a change of an electrical assembly during operation of the installation such that no critical states occur. In this case, one requirement in some areas of manufacturing installations is that voltage need not be removed from the installation or parts of the installation in order to replace the electrical assembly. However, for example, if the electrical assembly is connected to the mounting rack via a circuit such that it is impossible to preclude the possibility of a spark being formed at the plug between the electrical assembly and the mounting rack when the assembly is inserted or withdrawn, special design measures must be provided to reliably prevent this spark formation.

Patent specification DE 103 30 260 B4 discloses an assembly for insertion into a mounting rack. This apparatus has the disadvantage that the assembly cannot be safely supplied to a bus plug connector that is located on the mounting rack, and the assembly cannot be securely locked, as is necessary for industrial conditions, such as to prevent vibration and shock loads.

EP 0 419 694 B1 discloses an assembly for pivoting into a mounting rack, but this assembly has the disadvantage that it must be attached via two threaded bolts.

### SUMMARY OF THE INVENTION

It is therefore an object of the invention to provide an assembly which allows simple but secure locking and unlocking of the assembly.

This and other objects and advantages are achieved in accordance with the invention by arranging and mounting a locking lever on a housing of an assembly such that the locking lever can rotate, where a second holding means is arranged at a first end of the locking lever and a second end of the locking lever can be moved in the direction of the housing for the second holding means to engage in a second attachment means of the mounting rack. Starting from a preferably rectangular assembly which is similar to a box, the assembly has first to sixth faces, corresponding to its side surfaces. In order to pivot an assembly such as this into a mounting rack, it is normally connected by a first holding means, which is arranged on a first edge of the assembly, to the first attachment means, which is arranged on the mounting rack. By way of example, the assembly can then be pivoted onto or into the mounting rack by a pivoting joint. The assembly can be securely locked to the mounting rack by the locking lever, which is arranged on the third face of the housing, for example, with the first face representing an upper face of the assembly, and the third face representing a lower face of the assembly. For this purpose, the locking lever is arranged and mounted such that it can rotate at its rotation point on the assembly. In this case, the locking lever has a load arm and a force arm. The force arm is located, for example, on the left-hand side of the rotation point, and the load arm is located, for example, on the right-hand side of the rotation point. A force can now be transmitted via the force arm to the load arm, with the load arm having the second holding means, wherein the second holding means is configured such that it engages with the second attachment means of the mounting rack after a movement of the second end in the direction of the lower face of the housing. Here, the greater the movement distance which is traveled through by the load arm during a movement, the stronger the engagement of the second holding means with the second attachment means of the mounting rack, with the assembly thus being securely locked to the mounting rack.

In an advantageous embodiment, the second holding means has a pin which is suitable for entering a slotted-link guide. Here, the pin interacts with the slotted-link guide in the mounting rack such that the pin is guided along a rising slotted-link path by the rotary movement about the rotation point, thus resulting in an increasing pressure force of the assembly on the mounting rack.

In another advantageously optimized embodiment, the locking lever has a first limb, which is arranged on a centre part, and a second limb. These limbs are now each once again fitted with a pin, wherein the limbs are arranged on the left-hand side of the assembly and on the right-hand side of the assembly, in each case at an associated rotation point. Locking is further improved by the locking lever comprising a two-limbed lever with two pins. In a further advantageous, the first limb tapers from the first end to a second end of the locking lever.

In accordance with another embodiment, the locking lever comprises a shell at least partially surrounding the housing. If the locking lever is moved from an unlocked state to a locked state, then, in a final position in the locked state, the locking lever at least partially surrounds preferably three faces of the assembly. The lever comprising the shell can rest closely on parts of the housing, and is therefore located in a secure final position.

In a further advantageous embodiment, a latching means is arranged on the center part for latching with a recess that is arranged in the housing. The latching means preferably latches in the recess in the housing in the final position of the locking lever, thus increasing a holding force on the locking lever in its final position with respect to the lower face of the assembly. The latching means prevents the locking lever from being detached, for example by vibration, from the final position from the lower face of the assembly.

In a particularly preferred embodiment, a switching means is arranged on the locking lever in the area of the second end, wherein a switching element that is arranged in the housing can be operated via the switching means. In another advantageous embodiment, the switching element is configured to switch a power supply off and on. If there is a requirement for the control installation not to be switched such that it is not live during the replacement of an assembly from a mounting rack in an automation installation, such as because other areas of the control installation must continue to operate, such as for safety reasons, then it is frequently necessary for the live contacts of the assembly to be disconnected when live. This disconnection when live may possibly result in spark formation, which can result in damage to the contacts. Furthermore, abrupt disconnection of the assembly from the circuit of the mounting rack can cause damage to microelectronic circuits that are installed in the assembly. In order to prevent the abrupt disconnection and spark formation, the locking of the assembly to the mounting rack must be configured such that the assembly is internally disconnected when the locking lever is operated. This should at the same time ensure that the time between the internal disconnection of the assembly and the disconnection of the live contacts is sufficient to dissipate energies which are possibly stored in capacitances and/or inductances. When the assembly is plugged into the mounting rack, this mechanism should operate in the opposite form. The internal connection of the assembly must be possible only after the complete insertion process, with all contacts having made contact with a bus plug connector that is arranged on the assembly. Here, the function of the locking lever is to move the assembly, which has been suspended in the upper area of the mounting rack and is then pivoted downward, by a slotted-link system of the mounting rack into the bus plug connector to a mating piece of the mounting rack, and then to securely lock the assembly on the mounting rack.

If the switching means comprises a plug link, this plug link can enter a contact pair shortly before the locking lever reaches its final position, thus connecting the power supply for the assembly.

The objects of the invention are also met by the contemplated embodiments of the invention by a mounting rack for holding the assembly having a first attachment means and a second attachment means which is configured as a slotted-link guide in order to hold a pin.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The invention will be described and explained in more detail in the following text with reference to the exemplary embodiments which are illustrated in the figures, in which:

FIG. 1 shows a housing comprising a box in accordance with the prior art;

FIG. 2 shows an assembly and a mounting rack in accordance with an embodiment of the invention; and

FIG. 3 shows a detailed view of a switching means in a locking lever, and a switching element within the housing in accordance with an embodiment of the invention.

### DETAILED DESCRIPTION OF THE PRESENTLY PREFERRED EMBODIMENTS

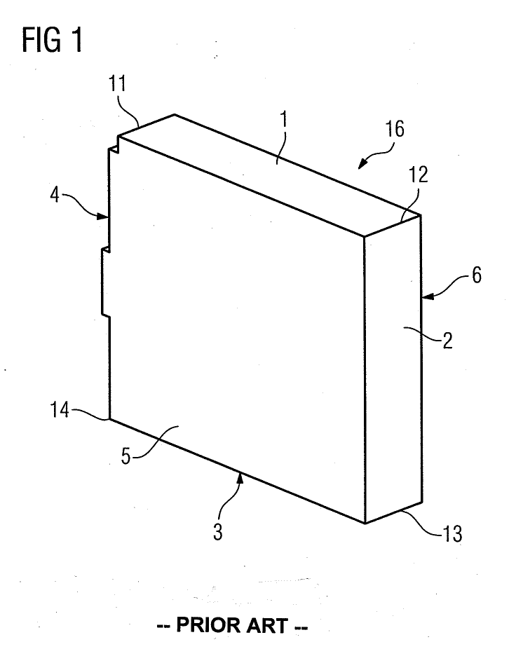

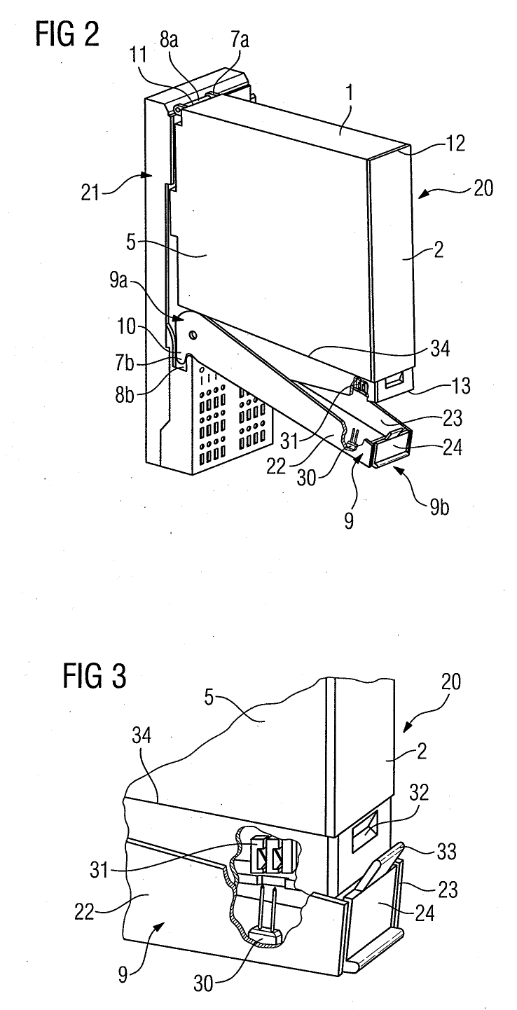

FIG. 1 shows a housing 16 in the form of a box, in accordance with the prior art and illustrates references points of the housing 16. The housing 16 comprises a rectangular box housing 16, and has a first through sixth face 1-6. Here, the fifth face 5 and the sixth face 6 represent the side surfaces of the housing 16 with the largest areas. In the corner areas of the housing 16, the housing 16 is designed with a first edge 11, a second edge 12, a third edge 13 and a fourth edge 14. The perspective illustration of the housing 16 shows it in an installed position in a mounting rack 21 (see FIG. 2). Here, the first face 1 represents an upper face of the housing 16, and the third face 3 represents a lower face of the housing 16. In a corresponding manner, the second face 2 of the housing 16 is regarded as the front face, and the fourth face 4 of the housing 16 is regarded as the rear face.

FIG. 2 shows an assembly 20 which can be pivoted into and out of a mounting rack 21. The assembly 20 comprises a rectangular box housing 16, as described in principle in FIG. 1. A first holding means 7a is arranged on the first edge 11 of the housing 16. A first attachment means 8a is arranged in the area of the first edge 11 on the mounting rack 21, as a mating piece for the first holding means 7a. The first holding means 7a and the first attachment means 8a together form a pivoting joint. By means of this pivoting joint, the assembly 20, which is now suspended in the upper area of the mounting rack and is connected to it, can be pivoted in the direction of the mounting rack 21. A locking lever 9 is arranged on the lower face of the housing 16 in the area of the fourth edge 14 of the housing 16. A second holding means 7b is arranged at a first end 9a of the locking lever 9 and is configured to engage in a second attachment means 8b on the mounting rack 21. A second end 9b of the locking lever 9 is moved in the direction of the assembly 20 by a rotary movement of the locking lever 9 about a rotation point. As a result of this movement, a pin 10 on the second holding means 7b can enter the second attachment means 8b, which is arranged on the mounting rack 21. Here, the second attachment means 8b comprises a slotted-link guide. The movement of the locking lever 9 in the direction of the lower face of the housing 16 allows the pin 10 to slide over the slotted-link guide, which comprises a ramp, thus moving the rear face of the assembly 20 increasingly in the direction of the mounting rack 21.

The locking lever 9 has a first limb 22 and a second limb 23, which are connected to one another via a center part 24. The center part 24 is arranged at the second end 9b of the locking lever 9. Starting from the rotation point on the housing 16, the two limbs 22, 23 of the locking lever 9 taper in the direction of the center part 24. The locking lever 9 comprises a handle like a shell. This handle can be moved at the rotation point in the direction of the housing 16, and the limbs 22, 23 as well as the center part 24, in this case, surround the lower face of the housing 16. When the locking lever 9 is in a final position, a latching means, which is arranged on the center part 24, can latch in a recess 32 that is arranged on the front face 2 of the housing 16 (see FIG. 3). On its rear face 4, the housing 16 has a plug which is configured to enter a mating piece on the mounting rack 21, and thus to make the electrical connections required between the mounting rack 21 and the assembly 20. Here, it is advantageous that insertion and withdrawal forces that occur in the plug are noticeably reduced by the locking lever 9 for a fitter, as a result of the lever effect of the locking lever 9. The movement process of the assembly 20 during pivoting into the mounting rack 21 can be summarized as follows. Starting from the connection of the assembly 20 at the pivoting joint 7a, 8a in the upper part of the mounting rack 21, the rear face 4 of the assembly 20 is pivoted with respect to the mounting rack 21. As the rear face 4 approaches the mounting rack 21, the pin 10 of the opened locking lever 9 finally arrives at a guide edge, which is arranged on the mounting rack 21, and makes contact with it. The guide edge merges into a slotted-link guide 8b. This slotted-link guide 8b has an incline on which the pin 10 can slide during a closing movement of the locking lever 9, and the rear face of the assembly 20 is pressed increasingly towards the mounting rack 21 by virtue of the rising shape of the slotted-link guide. At the end of the closing movement, the locking lever 9 has reached a final position, the latching means has latched into the recess 32, and edges of the first and second limbs 22, 23 are resting on a contact edge 34 of the housing 16, and in the end the assembly 20 is firmly locked to the mounting rack 21.

A switching means 30, which is arranged in the front area or in the area of the second end 9b of the locking lever 9, makes it possible to connect the assembly 20 at a very late point during the pivoting-in process and to disconnect it at a very early stage during the unlocking of the assembly 20. This early disconnection time during the unlocking of the assembly 20 is ensured by contacts of a switching element 31, such that the time between internal disconnection of the assembly 20 and disconnection of the live contacts in the bus plug connector is sufficient to disconnect a main circuit at an early stage, while still reliably dissipating energies stored in capacitances and/or inductances. The assembly 20 therefore ceases to be live at an early stage during a withdrawal process and the assembly becomes live at a later stage during an insertion process.

FIG. 3 shows a detailed view, as a detail from FIG. 2, of the switching means 30 arranged in the area of the second end 9b of the locking lever 9, and of the switching element 31 arranged in the housing 16 of the assembly 20. The switching means 30 comprises a plug link and can connect contacts on the switching element 11 when the locking lever 9 is completely closed. In order to ensure that the locking lever 9 latches in securely, a latching means is arranged on the center part 24 and can latch in a recess 32 in the housing 16 in the final position. This latch can be released via a clip 33, which is arranged on the center part 24, and the locking lever 9 can be moved in an opening direction.

A configuration such as this results in an assembly locking system. This advantageously allows secure attachment of the assembly 20 and, at the same time, release of the assembly 20 at as early a time as possible during an unlocking phase. Other advantages which are provided include a sufficient time offset between the opening of a plug link and the disconnection of the contact of a main circuit, a simple operating process, powerful assembly locking by a slotted link, vibration-resistant assembly attachment and vibration-resistant contact, minimization of incorrect actions, as well as fewer components for a locking mechanism, by virtue of the configuration. The prior art threaded bolts are therefore not needed and, furthermore, there is no longer any need for complex screw connection of the threaded bolts to lock the assembly, thus saving the fitter's time.

Thus, while there have been shown, described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. An assembly for pivoting into a mounting rack having a first attachment means and a second attachment means, comprising:
a housing having a first holding means arranged thereon for connection to the first attachment means of the mounting rack, wherein the housing is pivotable by a connection formed by the first holding means and the first attachment means;
a locking lever arranged and rotateably mounted on the housing; and
a second holding means arranged at a first end of the locking lever;
wherein a second end of the locking lever is moveable in a direction toward the housing and the second holding means engages in the second attachment means of the mounting rack when the second end move towards the housing.

2. The assembly as claimed in claim 1, wherein the second holding means includes a pin configured to enter a slotted-link guide located in the mounting rack.

3. The assembly as claimed in claim 1, wherein the locking lever includes a first limb and a second limb which are connected by a center part of the locking lever.

4. The assembly as claimed in claim 2, wherein the locking lever includes a first limb and a second limb which are connected by a center part of the locking lever.

5. The assembly as claimed in claim 3, wherein the first limb tapers from the first end to the second end of the locking lever.

6. The assembly as claimed in claim 1, wherein the locking lever comprises a shell configured to at least partially surround the housing.

7. The assembly as claimed in claim 3, further comprising:
a latching means arranged on the center part of the locking lever for latching with a recess arranged in the housing.

8. The assembly as claimed in claim 5, further comprising:
a latching means arranged on the center part of the locking lever for latching with a recess arranged in the housing.

9. The assembly as claimed in claim 6, further comprising:
a latching means arranged on the center part of the locking lever for latching with a recess arranged in the housing.

10. The assembly as claimed in claim 1, further comprising:
a switching means arranged on the locking lever in an area of the second end; and
a switching element is arranged in the housing, the switching element being operable by the switching means.

11. The assembly as claimed in claim 10, wherein the switching element is configured to switch a power supply off and on.

12. The assembly as claimed in claim 1, further comprising:
a plug which is arranged on the housing;
wherein the plug is pluggable into a mating piece of the mounting rack by the pivoting movement.

13. The assembly as claimed in claim 10, wherein the switching means comprises a plug link.

14. The assembly as claimed in claim 11, wherein the switching means comprises a plug link.

15. The assembly as claimed in claim 12, further comprising:
a switching means arranged on the locking lever in an area of the second end; and
a switching element is arranged in the housing, the switching element being operable by the switching means;
wherein the switching means comprises a plug link.

16. A mounting rack for holding an assembly for pivoting into a mounting rack having a first attachment means and a second attachment means, comprising:
a housing having a first holding means arranged thereon for connection to the first attachment means of the mounting rack, the housing being pivotable at a connection formed by the first holding means and the first attachment means;
a locking lever arranged and rotateably mounted on the housing; and
a second holding means arranged at a first end of the locking lever;
wherein a second end of the locking lever is moveable in a direction toward the housing and the second holding means engages in the second attachment means of the mounting rack when the second end moves toward the housing; and
wherein the second attachment means is configured as a slotted-link guide for holding a pin.
